(19) United States
(12) Patent Application Publication
(10) Pub. No.: US 2013/0063953 A1
(43) Pub. Date: Mar. 14, 2013

(54) LIGHT-EMITTING DIODE STRUCTURE

(71) Applicants: Den-Hua LEE, Hsinchu (TW); Kuan-Rong Lee, Hsinchu (TW); Chang-Jung Juan, Hsinchu (TW); Chen-Lieh Chen, Hsinchu (TW)

(72) Inventors: Den-Hua LEE, Hsinchu (TW); Kuan-Rong Lee, Hsinchu (TW); Chang-Jung Juan, Hsinchu (TW); Chen-Lieh Chen, Hsinchu (TW)

(21) Appl. No.: 13/231,677

(22) Filed: Sep. 13, 2011

(51) Int. Cl. F21V 5/04

(52) U.S. Cl. 362/311.02

(57) ABSTRACT

A light-emitting diode is provided, which comprises a baseplate; at least one semiconductor light-emitting element installed on the baseplate; and at least one deformable lens conducting a light beam emitted by the semiconductor light-emitting element. The deformable lens not only has a varifocal function but also can deform into a convex, plane, concave or irregular lens, and thus can adjust the light beam emitted by the semiconductor light-emitting element to have different patterns and present different optical signals.

### BACKGROUND OF THE INVENTION

1. Field of the Invention

The present invention relates to a light-emitting diode structure, more particular it relates to a light-emitting diode with a deformable lens capable of deforming into a concave lens, a convex lens, a plane lens or an irregular lens so as to control the status of the light beam of the light-emitting diode.

2. Description of the Related Art

The light-emitting diode (LED) is a solid-state light-emitting element made of a semiconductor material. The semiconductor material may be Group III-V semiconductor material, such as gallium phosphide (GaP) or gallium arsenide (GaAs). The principle of LED is to convert electrical energy into light, that is, current is applied to a compound semiconductor, and the recombination of electrons and holes releases energy in the form of light. LED is an electroluminescent element and has a lifespan of more than one hundred thousand hours.

LED has advantages of none idling time, fast response (about 10⁻⁹ second), small size, high power efficiency, vibration durability, low pollution, high reliability, and adequate for mass production. Further, LEDs can be fabricated in a very size or disposed as an array to meet the requirement of application.

Different types of LEDs made of different materials have different energy gaps occupied by electrons and holes, and the difference of the energy gaps determine the wavelength of the light released by the recombination of electrons and holes. Thus, different types of LEDs can emit lights of different colors, such as red, orange, yellow, green, blue, or invisible lights.

In spite of the above mentioned advantages, the light beam emitted by LED is constrained by its package structure, such that the status of the light beam is hard to be controlled according to requirements.

### SUMMARY OF THE INVENTION

One objective of the present invention is to provide a light-emitting diode (LED) with a deformable lens, wherein the deformable lens not only has a varifocal function but also can form a convex, plane, concave or irregular lens, whereby the status of the light beam emitted by the LED may not be constrained by the package structure but can be controlled to meet various requirements.

To achieve the abovementioned objective, the present invention disclosures a light-emitting diode with a deformable lens, which comprises a baseplate; at least one semiconductor light-emitting element arranged on the baseplate; and at least one lens for conducting the light beam emitted from the semiconductor light-emitting element.

The above mentioned deformable lens comprises a droplet, and a first electrode plate and a second electrode plate. The droplet is made of water, a liquid crystal, a light-permeable macromolecular material, or a light-permeable liquid dielectric material. The first electrode plate and the second electrode plate are arranged in parallel to clamp the droplet there between, whereby the droplet contacts the surfaces of the first electrode plate and the second electrode plate to form a lens. The first electrode plate has a plurality of first electrode units, and the second electrode plate has a plurality of second electrode units. The first electrode units can be selectively biased to create a first electric potential between the droplet and the electrodes of the first electrode units. The second electrode units can be selectively biased to create a second electric potential between the droplet and the electrodes of the second electrode units. By varying the first electric potential of the first electrode units or the second electric potential of the second electrode units can vary the contact area between the droplet and the first electrode units and the contact area between the droplet and the second electrode units. The surface tension of the droplet thus shapes the droplet to form a convex lens, a plane lens, a concave lens, or an irregular lens to adjust the pattern of the light beam emitted by the semiconductor light-emitting element.

The light-emitting diode with a deformable lens of the present invention comprises a baseplate; a semiconductor light-emitting element arranged on the baseplate; and a deformable lens conducting the light beam emitted from the semiconductor light-emitting element and adjusting the pattern of the light beam.

The present invention can achieve better results than the conventional technology in that the semiconductor light-emitting element is equipped with a deformable lens, which not only has a varifocal function but also can form a convex, plane, concave or irregular lens so as to adjust the light beam emitted by the semiconductor light-emitting element to have different patterns for presenting different optical signals.

### BRIEF DESCRIPTION OF THE DRAWINGS

FIG. 1 is a diagram schematically showing that a light beam of a semiconductor light-emitting element passes through a convex lens according to one embodiment of the present invention;

FIG. 2 is a diagram schematically showing that a light beam of a semiconductor light-emitting element passes through a plane lens according to one embodiment of the present invention;

FIG. 3 is a diagram schematically showing that a light beam of a semiconductor light-emitting element passes through a concave lens according to one embodiment of the present invention;

FIG. 4 is a diagram schematically showing that a light beam of a semiconductor light-emitting element passes through an irregular lens according to one embodiment of the present invention;

FIG. 5 is a diagram schematically showing that a single semiconductor light-emitting element cooperates with a plurality of lenses according to one embodiment of the present invention;

FIG. 6 is a diagram schematically showing that a plurality of semiconductor light-emitting elements cooperates with a plurality of lenses according to one embodiment of the present invention; and

FIG. 7 is a diagram schematically showing that a plurality of semiconductor light-emitting elements cooperates with a single lens according to one embodiment of the present invention.

### DETAILED DESCRIPTION OF THE INVENTION

The technical contents of the present invention are described in detail with the embodiments. However, it should be understood that these embodiments are only to exemplify the present invention but not to limit the scope of the present invention.

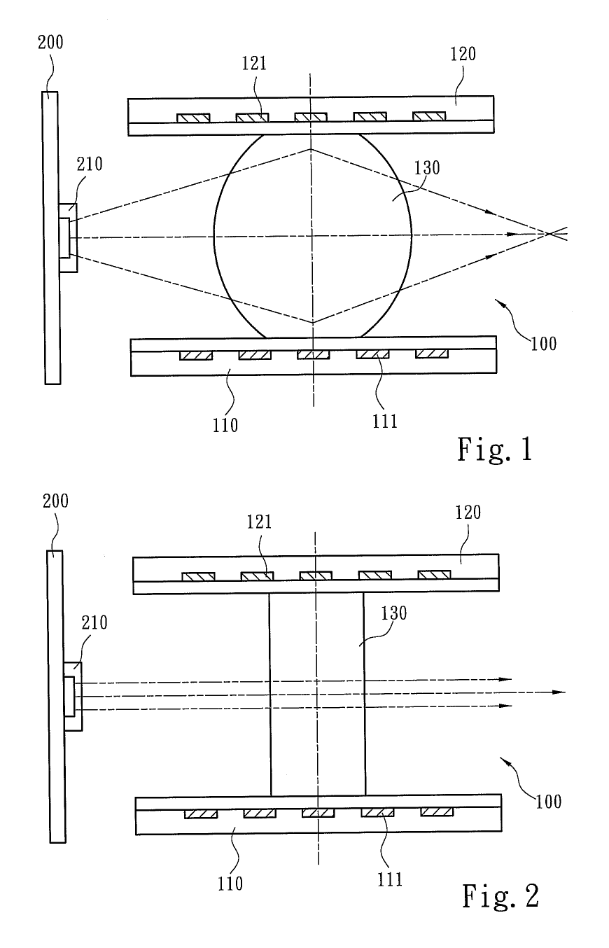

Refer to FIGS. 1-4 diagrams schematically showing a light-emitting diode with a deformable lens according to the present invention.

The light-emitting diode (LED) with a deformable lens of the present invention comprises a baseplate 200; a semiconductor light-emitting element 210 arranged on the baseplate 200 to form a basic LED light-emitting structure. The basic LED light-emitting structure is further packaged via a die-attaching process, a wire-bonding process, etc. The persons skilled in the art should be familiar with the related technology; thus it will not repeat herein. Then, a deformable lens 100 is placed in front of the semiconductor light-emitting element 210 to form a LED with the deformable lens 100 of the present invention.

In the present invention, a droplet is used as the lens, wherein the electrowetting (EW) effect is used to control the shape and curvature of the droplet and thus vary the focal length of the droplet. The deformable lens 100 of the present invention comprises a droplet 130, and a first electrode plate 110 and a second electrode plate 120. The droplet 130 is made of water, a liquid crystal, a light-permeable macromolecular material, or a light-permeable liquid dielectric. In fact, any light-permeable dielectric material can be used to form the droplet 130, such as the electronic-grade caster oil. The first electrode plate 110 and the second electrode plate 120 are arranged in parallel to clamp the droplet 130 therebetween, whereby each droplet 130 contacts the surfaces of the first electrode plate 110 and the second electrode plate 120 to form the lens 100. The first electrode plate 110 has a plurality of first electrode units 111, and the second electrode plate 120 has a plurality of second electrode units 121. The first electrode units 111 can be selectively biased to create a first electric potential between the droplet 130 and the electrodes of the first electrode units 111. The second electrode units 121 can be selectively biased to create a second electric potential between the droplet 130 and the electrodes of the second electrode units 121.

When the electric potential between the droplet 130 and the first/second electrode units 111/121 is varied, the surface tension of the droplet is also changed to cause the movement of the liquid. Such a phenomenon is the so-called electrowetting (EW) effect, and the operation of the EW effect is reversible. In the recent researches, it is found that coating a few microns-thick insulation films on the electrodes not only effectively promotes the reliability of the EW operation but also prevents from the electrode damage and liquid denaturation caused by electrolysis. Such an improved technology is the so-called EWOD (ElectroWetting-On-Dielectric). Thus, by varying the surface electric potential of the droplet can control the liquid movement on the solid. The droplet is apt to move toward an electrode having a higher electric potential, and the electrode is function like a magnet. The higher the electric potential of the electrode is, the stronger the force attracts the droplet.

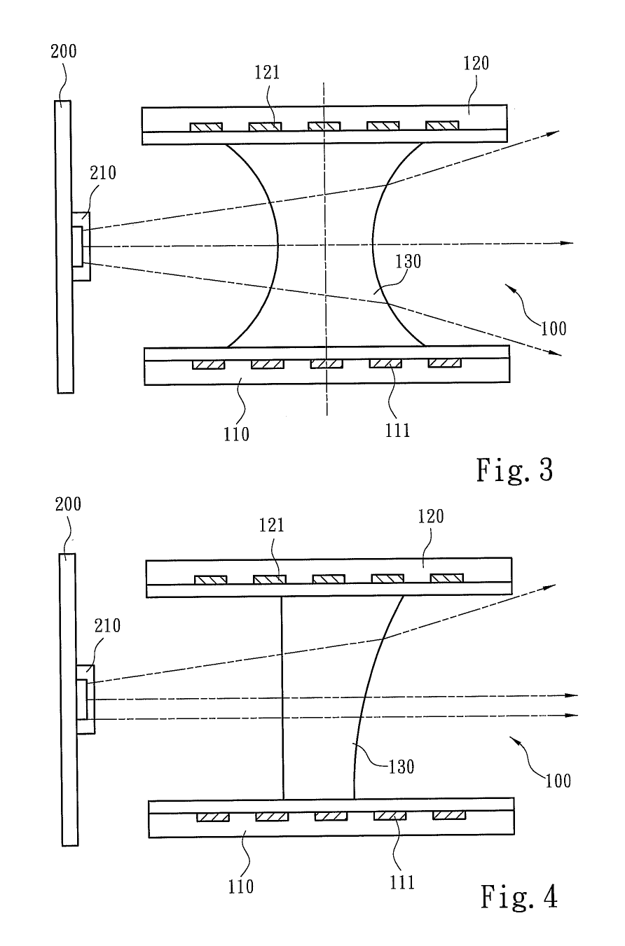

According to the principle mentioned above, by varying the first electric potential between the droplet 130 and the first electrode plate 110 or by varying the second electric potential between the droplet 130 and the second electrode plate 120, the contact area and surface tension between the droplet 130 and the first electrode plate 110 or the contact area and surface tension between the droplet 130 and the second electrode plate 120 is changed. Controlling the surface tension of the droplet 130 can further modify the curvature of the droplet 130. In other words, the focal length of the lens 100 can be modified via varying the first electric potential between the droplet 130 and the first electrode plate 110 or varying the second electric potential between the droplet 130 and the second electrode plate 120. Further, the curvature of the droplet 130 can be modified to form various types of lenses, such as a convex lens shown in FIG. 1, a plane lens shown in FIG. 2, a concave lens shown in FIG. 3, and an irregular lens shown in FIG. 4. In FIG. 4, the upper contact area contacting the second electrode plate 120 is greater than the lower contact area contacting the first electrode plate 110, and an inverse-trapezoid-like lens is thus formed.

Therefore, the status of the light beam emitted by the semiconductor light-emitting element 210 can be changed by varying the focal length and shape of the droplet 130 of the lens 100. When the droplet 130 is deformed into a convex lens, the light beam emitted by the semiconductor light-emitting element 210 is converged, as shown in FIG. 1. When the droplet 130 is deformed into a plane lens, the light beam emitted by the semiconductor light-emitting element 210 passes through the droplet 130 parallel, as shown in FIG. 2. When the droplet 130 is deformed into a concave lens, the light beam emitted by the semiconductor light-emitting element 210 is diverged, as shown in FIG. 3. When the droplet 130 is deformed into an irregular lens, such as the inverse-trapezoid-like lens shown in FIG. 4, one half of the light beam emitted by the semiconductor light-emitting element 210 is diverged, and the other half of the light beam passes through the droplet 130 in parallel. Therefore, by varying the first electric potential of the first electrode plate 110 or the second electric potential of the second electrode plate 120 can adjust the focal length of the lens 100 or change the curvature of the droplet 130 to attain various types of lenses. Thereby, the light beam emitted by the semiconductor light-emitting element 210 can be modified into various modes.

In the present invention, as the droplet 130 is clamped by two electrode plates 110 and 120, the light path passes through the droplet 130 but it does not pass through the baseplate or the electrodes. Thus, less energy is dissipated in transmission, and the light transmittance is increased.

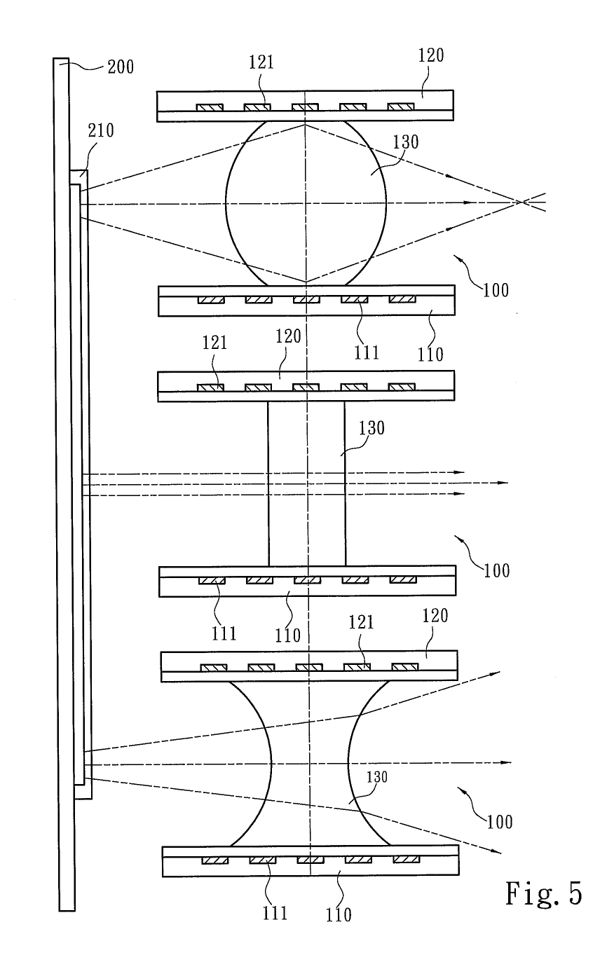

Refer to FIG. 5 for one embodiment of the present invention. In this embodiment, a plurality of deformable lenses 100 is installed in front of a single semiconductor light-emitting element 210 on the baseplate 200. The deformable lenses 100 may be arranged in an array. The shape and curvature of the droplet 130 of each deformable lens 100 can be controlled to form a convex lens, a plane lens, a concave lens, or an irregular lens. Thus a light beam control mode implemented by a plurality of deformable lenses 100 is formed.

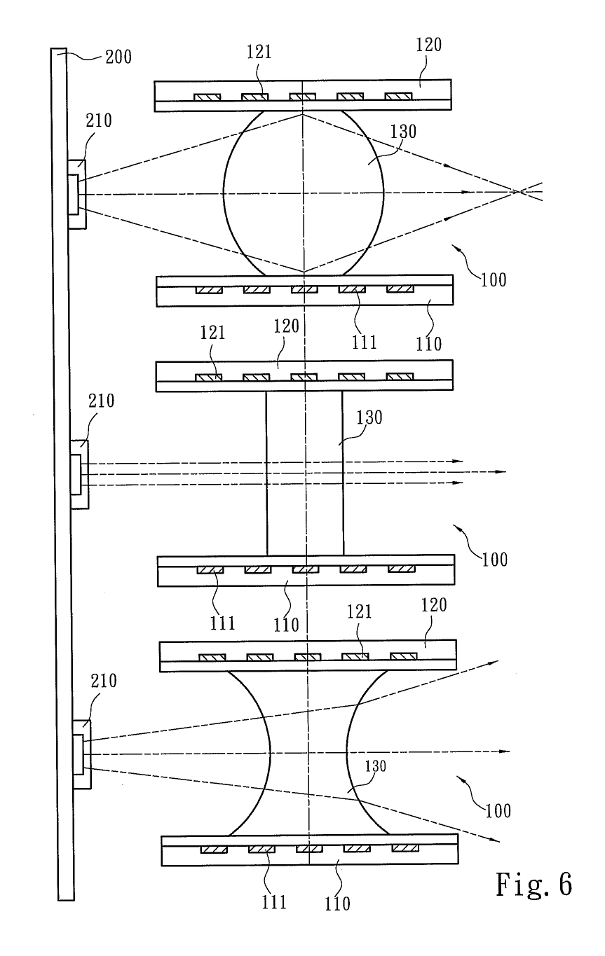

Refer to FIG. 6 for another embodiment of the present invention. In this embodiment, a plurality of deformable lenses 100 is correspondingly installed in front of a plurality of semiconductor light-emitting elements 210 on the baseplate 200. The semiconductor light-emitting elements 210 and the deformable lenses 100 may be respectively arranged in an array. In this embodiment, the semiconductor light-emitting elements 210 can be respectively switched on or off, and the shape and curvature of the droplet 130 of each deformable lens 100 can be controlled to form a convex lens, a plane lens, a concave lens, or an irregular lens. Thus a light beam control mode via controlling a plurality of semiconductor light-emitting elements 210 and a plurality of deformable lenses 100 is formed.

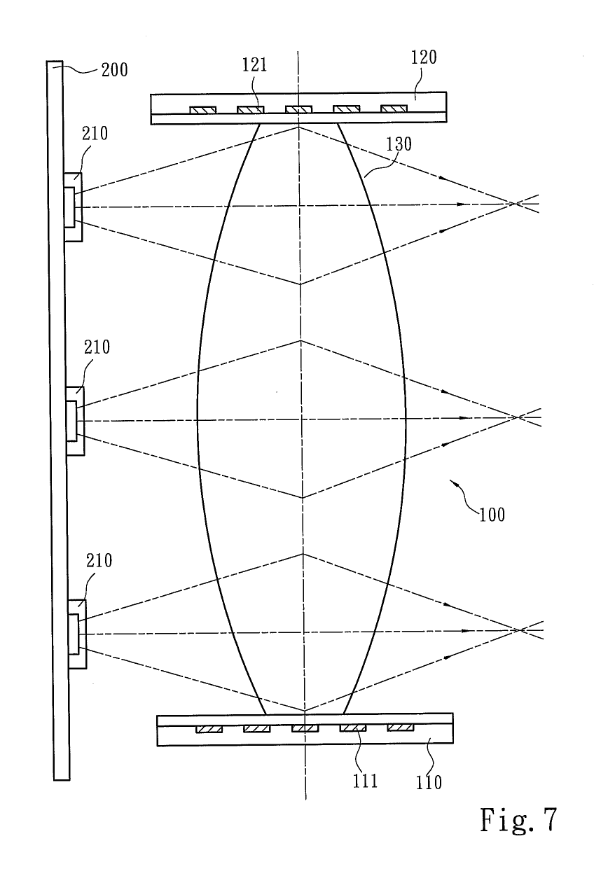

Refer to FIG. 7 for a further embodiment of the present invention. In this embodiment, a single deformable lens 100 is installed in front of a plurality of semiconductor light-emitting elements 210 on the baseplate 200. The semiconductor light-emitting elements 210 may be arranged in an array. In this embodiment, the semiconductor light-emitting elements 210 can be respectively switched on or off, and the shape and curvature of the droplet 130 of the deformable lens 100 can be controlled to form a convex lens, a plane lens, a concave lens, or an irregular lens. Thus a light beam control mode via controlling a plurality of semiconductor light-emitting elements 210 and a single deformable lens 100 is formed.

The embodiments described above are only to exemplify the present invention but not to limit the scope of the present invention. Any equivalent modification or variation according to the spirit of the present invention is to be also included within the scope of the present invention.

1. A light-emitting diode structure, comprising
a baseplate;
at least one semiconductor light-emitting element installed on said baseplate; and
at least one deformable lens comprising:
a droplet; and
a first electrode plate and a second electrode plate arranged in parallel to clamp said droplet and make said droplet contact said first electrode plate and said second electrode plate to form said lens, and said first electrode plate including a plurality of first electrode units and said second electrode plate including a plurality of second electrode units, said first electrode units and said second electrode units being selectively biased to create a first electric potential between said droplet and said first electrode units and a second electric potential between said droplet and said second electrode units,
wherein by varying said first electric potential of said first electrode plate and said second electric potential of said second electrode plate, a contact area between said droplet and said first electrode plate and a contact area between said ell droplet and said second electrode plate can be adjusted such that said droplet can form said lens with various shapes due to surface tension, and said lens guides lights emitted from said semiconductor light-emitting element, and control and adjust light shapes of said lights.

2. The light-emitting diode structure according to claim 1, wherein said droplet is made of water, a liquid crystal, a light-permeable macromolecular material, or a light-permeable liquid dielectric material.

3. (canceled)

4. A light-emitting diode structure, comprising
a baseplate;
at least one semiconductor light-emitting element installed on said baseplate; and
at least one deformable lens comprising:
a droplet; and
a first electrode plate and a second electrode plate arranged in parallel to clamp said droplet and make said droplet contact said first electrode plate and said second electrode plate to form said lens, and said first electrode plate including a plurality of first electrode units and said second electrode plate including a plurality of second electrode units, said first electrode units and said second electrode units being selectively biased to create a first electric potential between said droplet and said first electrode units and a second electric potential between said droplet and said second electrode units,
wherein by varying said first electric potential of said first electrode plate and said second electric potential of said second electrode plate, a contact area between said droplet and said first electrode plate and a contact area between said droplet and said second electrode plate can be adjusted such that said droplet can form said lens with various shapes due to surface tension, and said lens guides lights emitted from said semiconductor light-emitting element, and control and adjust light shapes of said lights.
wherein said surface tension of said droplet shapes of said droplet includes a convex lens, a plane lens, a concave lens, or an irregular lens.
